(19) United States
(12) Patent Application Publication
(10) Pub. No.: US 2025/0322150 A1
(43) Pub. Date: Oct. 16, 2025

(54) METHOD, DEVICE, AND COMPUTER PROGRAM PRODUCT FOR GENERATING RESPONSE ABOUT DOCUMENT

(71) Applicant: Dell Products L.P., Round Rock, TX (US)

(72) Inventors: Zijia Wang, London (GB); Jinpeng Liu, Shanghai (CN); Sanping Li, Beijing (CN); Zhen Jia, Shanghai (CN)

(21) Appl. No.: 18/678,065

(22) Filed: May 30, 2024

(30) Foreign Application Priority Data
Apr. 12, 2024 (CN) 202410444899.X

(51) Int. Cl. G06F 40/194; G06F 16/93; G06F 40/205; G06F 40/35; G06N 20/00

(52) U.S. Cl. CPC G06F 40/194; G06F 16/93; G06F 40/35; G06N 20/00; G06F 40/205

(57) ABSTRACT

The present disclosure relates to a method, a device, and a computer program product for generating a response about a document. The method includes: according to a first document, retrieving multiple second documents associated with the first document; determining duplication between the first document and the multiple second documents through contextual analysis of the first document and the multiple second documents; determining gaps between the first document and the multiple second documents through causal analysis of the first document and the multiple second documents; and generating a response about the first document according to the duplication and the gaps using a language model. In this way, by considering both the context and the causality in various documents, it is possible to conduct duplication and gap detection for more complex documents, and thus generate a more accurate response about the document.

### RELATED APPLICATION

The present application claims priority to Chinese Patent Application No. 202410444899.X, filed Apr. 12, 2024, and entitled “Method, Device, and Computer Program Product for Generating Response about Document,” which is incorporated by reference herein in its entirety.

### FIELD

The present disclosure relates to the field of artificial intelligence, and more particularly, to a method, a device, and a computer program product for generating a response about a document.

### BACKGROUND

Documents are basic sources of information and knowledge in various files and applications. With respect to documents, duplication detection and gap detection are important tasks which have many applications in various fields, such as plagiarism detection, information retrieval, text summarization, text clustering, and research proposals. Duplication detection refers to detecting similarities between multiple documents, and gap detection refers to detecting differences between multiple documents. The duplication detection and gap detection of documents can usually be performed together (referred to as duplication and gap detection for short). By comparing multiple documents, a response about a document is generated, the response being associated with the duplication and gaps between this document and other documents.

Document comparison usually relies on simple keyword matching. Such methods compare documents by extracting keywords from different documents and cannot understand the substantial content in the documents, so the presented response about a document when dealing with complex document comparison may be wrong. The complexities of document comparison may, for example, come from lexical variability, such as one word with multiple meanings or multiple synonyms with the same meaning, and document structural variability, such as different formats or architectures. These complexities pose a challenge for generating a response about a document through duplication and gap detection.

### SUMMARY

Embodiments of the present disclosure provide a method, a device, and a computer program product for generating a response about a document. According to embodiments of the present disclosure, by considering both the context and the causality in various documents, it is possible to conduct duplication and gap detection for more complex documents, and thus generate a more accurate response about a first document.

In an aspect of the present disclosure, a method for generating a response about a document is provided. The method includes: according to a first document, retrieving multiple second documents associated with the first document; determining duplication between the first document and the multiple second documents through contextual analysis of the first document and the multiple second documents; determining gaps between the first document and the multiple second documents through causal analysis of the first document and the multiple second documents; and generating a response about the first document according to the duplication and the gaps using a language model.

In another aspect of the present disclosure, an electronic device is provided. The electronic device includes at least one processor and a memory, where the memory is coupled to the at least one processor and has instructions stored therein. The instructions, when executed by the at least one processing unit, cause the electronic device to perform actions including: according to a first document, retrieving multiple second documents associated with the first document; determining duplication between the first document and the multiple second documents through contextual analysis of the first document and the multiple second documents; determining gaps between the first document and the multiple second documents through causal analysis of the first document and the multiple second documents; and generating a response about the first document according to the duplication and the gaps using a language model.

In another aspect of the present disclosure, a computer program product is provided. The computer program product is tangibly stored on a non-transitory computer-readable medium and includes machine-executable instructions. The machine-executable instructions, when executed by a machine, cause the machine to perform actions including: according to a first document, retrieving multiple second documents associated with the first document; determining duplication between the first document and the multiple second documents through contextual analysis of the first document and the multiple second documents; determining gaps between the first document and the multiple second documents through causal analysis of the first document and the multiple second documents; and generating a response about the first document according to the duplication and the gaps using a language model.

It should be understood that the content described in this Summary is neither intended to define key or essential features of embodiments of the present disclosure, nor intended to limit the scope of the present disclosure. Other features of the present disclosure will become readily understood from the additional description provided herein.

### BRIEF DESCRIPTION OF THE DRAWINGS

The above and other features, advantages, and aspects of embodiments of the present disclosure will become more apparent with reference to the accompanying drawings and the following Detailed Description. In the accompanying drawings, identical or similar reference numerals represent identical or similar elements, in which:

FIG. 1 is a schematic diagram of an example environment in which multiple embodiments of the present disclosure can be implemented;

FIG. 2 is a flow chart of a method for generating a response about a document according to some embodiments of the present disclosure;

FIG. 3 is a schematic diagram of a process of retrieving multiple second documents associated with a first document according to some embodiments of the present disclosure;

FIG. 4 is a flow chart of a method for retrieving multiple second documents associated with a first document according to some embodiments of the present disclosure;

FIG. 5 is a flow chart of a method for determining similarities between a first document and multiple documents in a document library according to some embodiments of the present disclosure;

FIG. 6 is a schematic diagram of an architecture of contextual analysis of a document according to some embodiments of the present disclosure;

FIG. 7 is a schematic diagram of a process of training a duplication detection module according to some embodiments of the present disclosure;

FIG. 8 is a schematic diagram of a process of gap detection according to some embodiments of the present disclosure;

FIG. 9 is a flow chart of a method for gap detection according to some embodiments of the present disclosure; and

FIG. 10 is a block diagram of a device that can implement multiple embodiments of the present disclosure.

### DETAILED DESCRIPTION

Illustrative embodiments of the present disclosure will be described below in further detail with reference to the accompanying drawings. Although the accompanying drawings show some embodiments of the present disclosure, it should be understood that the present disclosure can be implemented in various forms, and should not be construed as being limited to the embodiments stated herein. Rather, these embodiments are provided for understanding the present disclosure more thoroughly and completely. It should be understood that the accompanying drawings and embodiments of the present disclosure are for illustrative purposes only, and are not intended to limit the scope of protection of the present disclosure.

In the description of embodiments of the present disclosure, the term “include” and similar terms thereof should be understood as open-ended inclusion, that is, “including but not limited to.” The term “based on” should be understood as “based at least in part on.” The term “an embodiment” or “the embodiment” should be understood as “at least one embodiment.” The terms “first,” “second,” and the like may refer to different or identical objects. Other explicit and implicit definitions may also be included below.

As described previously, documents are basic sources of information and knowledge in various files and applications. With respect to documents, duplication detection and gap detection are important tasks which have many applications in various fields, such as plagiarism detection, information retrieval, text summarization, text clustering, and research proposals. Duplication detection refers to detecting similarities between multiple documents, and gap detection refers to detecting differences between multiple documents. The duplication detection and gap detection of documents can usually be performed together (referred to as duplication and gap detection for short). By comparing multiple documents, a response about a document is generated, the response being associated with the duplication and gaps between this document and other documents.

Conventional document comparison relies on manual check or simple keyword matching. Such methods compare documents merely by extracting keywords from the documents, and cannot understand the substantial content in the documents, so the presented response about a document when dealing with complex document comparison may be wrong. The complexities of document comparison may, for example, come from lexical variability, such as a word with multiple meanings or synonyms with the same meaning, and document structural variability, such as different formats or architectures. These complexities pose a challenge for generating a response about a document through duplication and gap detection.

In view of this, embodiments of the present disclosure provide a solution for generating a response about a document. In an embodiment of the present disclosure, according to a first document, multiple second documents associated with the first document are retrieved. Duplication between the first document and the multiple second documents is determined through contextual analysis of the first document and the multiple second documents. Gaps between the first document and the multiple second documents are determined through causal analysis of the first document and the multiple second documents. A response about the first document is generated according to the duplication and the gaps using a language model.

In this way, it is possible to determine the duplication between the first document and the multiple second documents associated with the first document through the contextual analysis of the first document and the multiple second documents, determine the gaps between the first document and the multiple second documents through the causal analysis of the first document and the multiple second documents, and generate a response about the first document according to the duplication and the gaps using a language model. By considering both the context and the causality in various documents, it is possible to conduct duplication and gap detection for more complex documents, and thus generate a more accurate response about the first document.

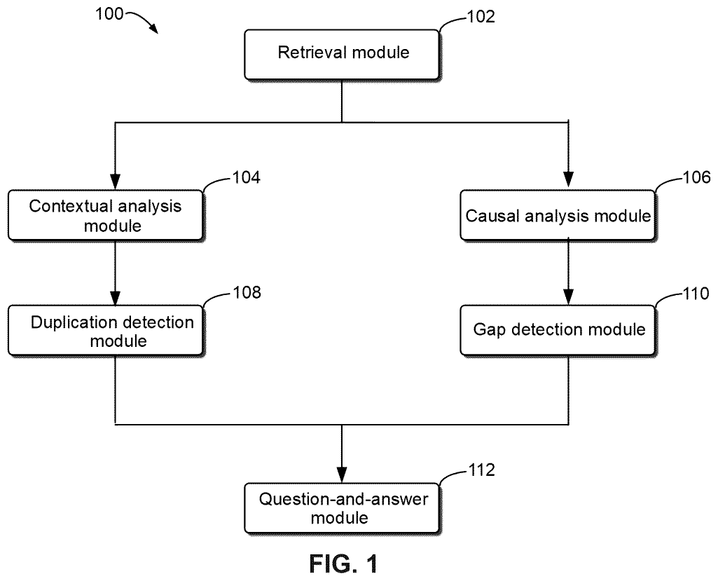

FIG. 1 is a schematic diagram of an example of an environment 100 in which multiple embodiments of the present disclosure can be implemented. For example, the environment 100 is configured to generate a response about a document. As a more particular example, the environment 100 may be configured to generate a response about a first document, where the response is associated with the duplication and gaps between the first document and multiple second documents. As shown in FIG. 1, the environment 100 includes a retrieval module 102, a contextual analysis module 104, a causal analysis module 106, a duplication detection module 108, a gap detection module 110, and a question-and-answer (Q&A) module 112. It should be understood that the types and number of the modules, the process, the arrangement, and the like shown in FIG. 1 are only illustrative. It should be understood that the above examples are only used to illustrate the application of various modules.

In some embodiments, the document may include various forms of text files, such as reports, research proposals, papers, instructions, chart documents, and the like. In some embodiments, the first document is also called a target document, a query document, or a query, and the multiple second documents associated with the first document are also called multiple other documents or retrieved documents. For example, the multiple second documents are included in a document library or a corpus. A document library or corpus refers to a collection of all documents used for comparison with the first document. In other words, the second documents refer to those documents associated with the first document that are retrieved from the document library. Document library documents or corpus documents refer to all documents in the document library, including the second documents.

As shown in FIG. 1, the retrieval module 102 can retrieve multiple other documents associated with the target document according to the target document. In some embodiments, the retrieval module 102 may include a transformer-based model and a Graph Neural Network (GNN) for understanding the context and semantics within the documents and modeling the relationships between the documents. The documents retrieved by the retrieval module 102 and the target document are delivered to the contextual analysis module 104 and the causal analysis module 106 for duplication detection and gap detection.

The contextual analysis module 104 is configured for contextual analysis of documents. In some embodiments, the contextual analysis module 104 may include a capsule network and discourse analysis for understanding a hierarchical relationship and a substantial relationship within a document. It should be understood that the hierarchical relationship herein refers to the structural architecture among multiple parts of a document, such as chapters, titles, subheadings, and paragraphs, and the substantial relationship refers to the discourse relationship, the sentiment relationship, and the like among the multiple parts of the document. The substantial relationship is also called social relationship herein.

The document contextually analyzed by the contextual analysis module 104 is delivered to the duplication detection module 108. The duplication detection module 108 is configured to determine the duplication between the target document and the multiple other documents according to the target document and the multiple other documents that are contextually analyzed. In an embodiment, the duplication detection module 108 may include a Siamese network to learn a semantic similarity between different documents.

As shown in FIG. 1, the causal analysis module 106 is configured for causal analysis of the documents. In some embodiments, the causal analysis module 106 includes a capsule network and an attention mechanism for inferring the causal relationship within a document and for weighing the importance of different parts of the document, thereby improving the contextual understanding and the semantic similarity.

The document causally analyzed by the causal analysis module 106 is delivered to the gap detection module 110. The gap detection module 110 is configured to determine gaps between a target document and multiple other documents according to the target document and the multiple other documents that are causally analyzed. In some embodiments, the gap detection module 110 includes a zero-shot learning network for identifying new and uncovered areas in the target document. This process may also be called novelty or novel cluster detection.

As shown in FIG. 1, the environment 100 further includes the question-and-answer module 112 configured to generate a response about the target document according to the duplication and the gaps between the target document and the other documents. It should be understood that the response about a document herein may include answering questions about the document, such as information from the document, understanding of the document, duplication (similarity) between the target document and the multiple other documents, differences between the target document and the multiple other documents, and potential research directions of the target document. In some embodiments, the response about the first document may refer to answering questions associated with the first document.

In some embodiments, the question-and-answer module 112 may include a large language model (LLM) for answering questions about new documents. In some embodiments, the question-and-answer module 112 may be configured to generate a response of a new research direction (e.g., a potential research issue, theory, or method) of the target document according to the identified new and uncovered areas.

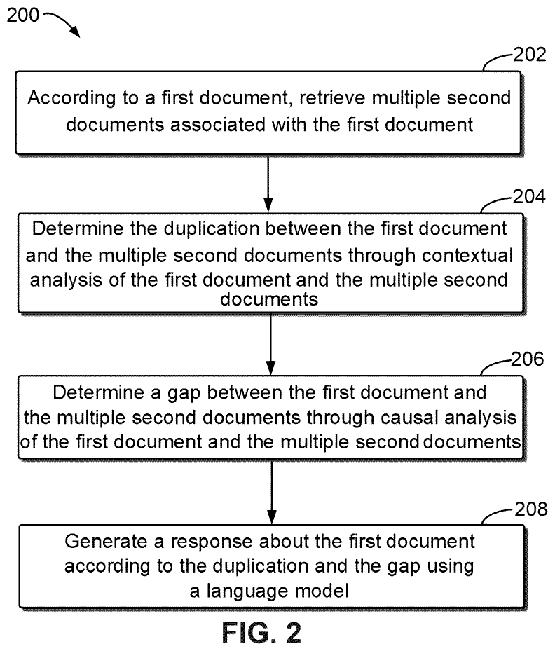

FIG. 2 is a flow chart of a method 200 of generating a response about a document according to some embodiments of the present disclosure. In order to better describe the method 200, it will be described below with reference to the example environment 100 depicted in FIG. 1.

At 202, according to the first document, multiple second documents associated with the first document are retrieved. For example, the multiple second documents associated with the first document are retrieved by the retrieval module 102 in FIG. 1. In some embodiments, for a given query document (first document), the retrieval module 102 retrieves multiple second documents most relevant to the given query document from a large document library. In some embodiments, the retrieval module 102 uses a transformer-based model, for example, Bidirectional Encoder Representations from Transformers (BERT), for semantic understanding, and a GNN for modeling the relationship between different documents.

In some embodiments, the transformer-based model is a neural network architecture that uses an attention mechanism to encode and decode sequential data (such as natural language). BERT is a pre-trained transformer-based model, which can be fine-tuned for various natural language processing tasks, such as text classification, question and answer, and semantic similarity. In some embodiments, BERT can capture the semantics of a document by encoding the document as a contextualized vector in a high-dimensional space.

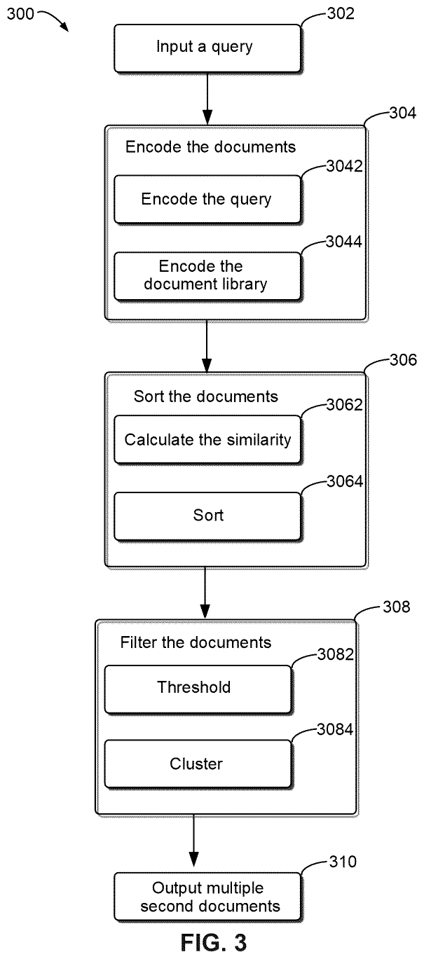

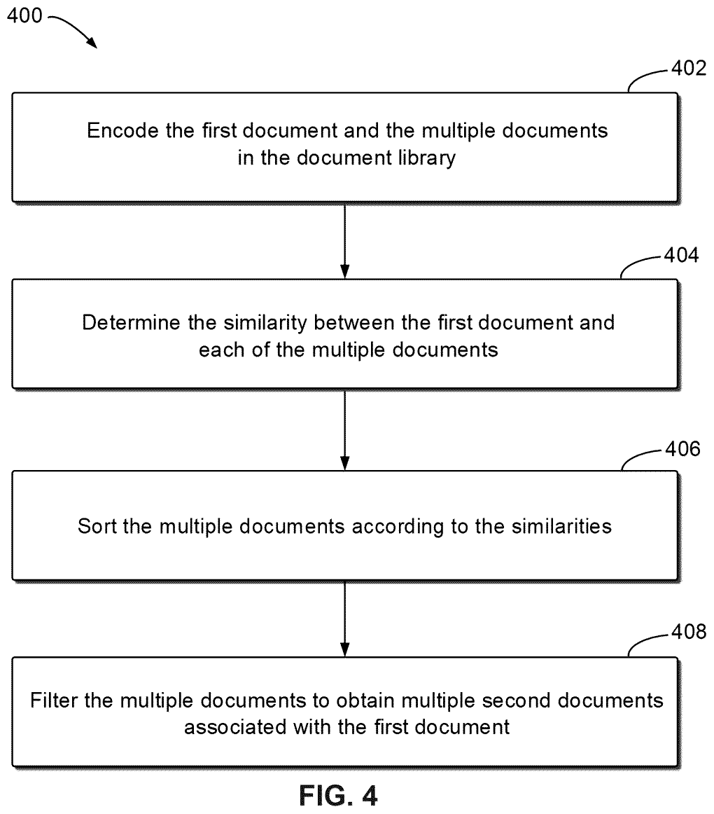

In some embodiments, GNN is a neural network architecture that can operate on graph structured data, such as social networks, knowledge graphs, and document collections. GNN can model the relationship between different nodes in a graph by gathering information along the edge. GNN can capture the structural and relational features of a document by encoding the document as a graph embedding in a low-dimensional space. Hereinafter, retrieval of multiple second documents is to be illustrated with reference to the process 300 shown in FIG. 3 and the method 400 shown in FIG. 4.

At 204, the duplication between the first document and the multiple second documents is determined through contextual analysis of the first document and the multiple second documents. For example, the contextual analysis module 104 and the duplication detection module 108 in FIG. 1 determine the duplication between the first document and the multiple second documents through contextual analysis of the first document and the multiple second documents. In some embodiments, the contextual analysis module 104 in FIG. 1 can perform contextual analysis on the first document and the multiple second documents respectively, and the duplication detection module 108 can determine the duplication between the first document and the multiple second documents according to the first document and the multiple second documents that are contextually analyzed.

In some embodiments, analysis within a document may refer to analysis of multiple parts of the document. For example, contextual analysis within the document may refer to contextual analysis of multiple parts of the document. For example, causal analysis within the document may refer to causal analysis of multiple parts of the document. In some embodiments, a part may also be called a snippet or a text snippet, which may refer to a page, an item, a chapter, a paragraph, a sentence, or the like of the document.

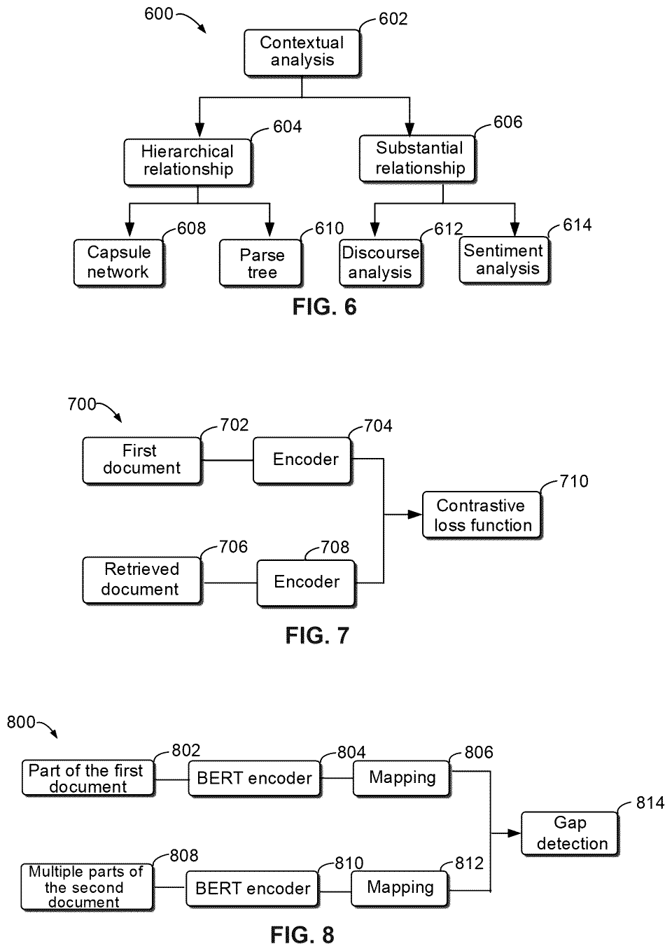

In some embodiments, the contextual analysis of the first document includes determining, by the contextual analysis module 104, the hierarchical relationship between multiple parts of the first document and the substantial relationship between multiple parts of the first document. For example, the contextual analysis module 104 determines the hierarchical relationship by using the capsule network and the discourse analysis. For example, the substantial relationship includes the discourse relationship and the sentiment relationship between multiple parts of the document. Contextual analysis will be illustrated below with reference to an architecture 600 of contextual analysis shown in FIG. 6.

In some embodiments, determining the duplication between the first document and the second documents includes the duplication detection module 108 training a Siamese network by using multiple documents in a document library, and comparing the first document contextually analyzed with the multiple second documents contextually analyzed by using the trained Siamese network to determine the duplication between the first document and the multiple second documents. Hereinafter, the Siamese network is to be illustrated with reference to the training process 700 shown in FIG. 7.

At 206, the gaps between the first document and the multiple second documents are determined through causal analysis of the first document and the multiple second documents. For example, the causal analysis module 106 and the gap detection module 110 in FIG. 1 determine the gaps between the first document and the multiple second documents through causal analysis of the first document and the multiple second documents. In some embodiments, the causal analysis module 106 can perform causal analysis on the first document and the multiple second documents, and the gap detection module 110 can determine the gaps between the first document and the multiple second documents according to the first document and the multiple second documents that are causally analyzed. In some embodiments, the gap may refer to the novelty of the first document, that is, the new and uncovered areas in the target document. The novelty can be used to generate responses related to novel research directions, issues, theories, or methods of the first document.

In some embodiments, the causal analysis of the first document includes the causal analysis module 106 determining a graphical representation of the causal relationship between multiple parts of the first document and determining attention weights of the multiple parts of the first document in the graphical representation. In some embodiments, the causal analysis of the first document further includes the causal analysis module 106 sorting the attention weights of the multiple parts of the first document; applying a first threshold to the attention weights of the multiple parts; and selecting the part of the first document whose attention weight is higher than the first threshold as the first document causally analyzed.

At 208, a response about the first document is generated according to the duplication and the gaps using a language model. For example, the question-and-answer module 112 in FIG. 1 generates a response about the first document according to the duplication from the duplication detection module 108 and the gaps from the gap detection module 110 by using a language model. For example, the language module may be an LLM.

In some embodiments, generating a response about the first document includes: performing a nearest neighbor search on a mapped first embedding by the gap detection module 110 to determine multiple novel clusters associated with the first embedding. For example, the novel cluster may indicate a response about the first document. In some embodiments, generating a response about the first document further includes generating a response about the first document by the question-and-answer module 112 based on the novel cluster. In this embodiment, the response about the first document indicates the novelty of the first document, that is, new and uncovered research directions, research issues, theories, methods, or the like.

In some embodiments, the question-and-answer module 112 is designed to answer relevant questions about the first document based on the contextual information from the multiple retrieved second documents. The question-and-answer module 112 is fine-tuned for question answering using a transformer-based architecture. In some embodiments, a question about the first document is given, and the question and the retrieved second document are used as inputs to the question-and-answer module 112. In some embodiments, the question-and-answer module 112 obtains the contextual understanding needed to answer questions by using multi-head self-attention. In some embodiments, the output of the question-and-answer module 112 is the generated answer with relevant text snippets highlighted.

In some embodiments, the question-and-answer module 112 can be implemented as an advanced transformer-based model (such as BERT) and a generative pre-trained transformer (GPT). The performance of the question-and-answer module 112 can be further improved by fine-tuning the domain-specific data. By providing relevant answers from the multiple retrieved second documents, the question-and-answer module 112 enables a user to gain additional insight beyond the content existing in the first document itself. This is helpful for more in-depth analysis. It should be understood that the above models, networks, or algorithms are provided as examples only, and different models, networks, or algorithms can be used to implement the question-and-answer module 112.

Through the method 200, by considering both the context and the causality in various documents and comparing the context and the causality between the documents, it is possible to conduct duplication and gap detection for more complex documents, and the response thus generated about the first document is more accurate.

FIG. 3 is a schematic diagram of a process 300 of retrieving multiple second documents associated with a first document according to some embodiments of the present disclosure. The retrieval process 300 can be performed by the retrieval module 102 of FIG. 1.

At 302, a query document is input. The query or query document herein refers to the target document or the first document. At 304, the query document and the document library document (referred to as document library for short) are encoded by a document encoding module. Encoding the documents includes encoding the query document to obtain a vector of the query document (or query vector) at 3042, and encoding the document in the document library to obtain a vector of the document library document (or document library vector) at 3044.

In some embodiments, the document encoding module is intended to encode each document of the document library document and the query document into a vector representation that captures its semantic and structural features. The document encoding module uses BERT and GNN to achieve this goal. First, each document is encoded by BERT as a contextualized vector (BERT vector) in a high-dimensional space. The BERT vector captures the semantics of the document based on its words and context. In some embodiments, the BERT vector is obtained by applying an average pooling operation to the output vector of the last hidden layer of BERT for each token in the document.

In this embodiment, BERT can be used to extract the features of text semantics and understand in-depth the text semantics behind keywords, which can provide more accurate retrieval results, and thus provide a more accurate response about the query document.

Then, each document is encoded by GNN as a graph embedding in a low-dimensional space. Graph embedding captures the structural and relational features of the document based on its position and concatenation in the document graph. A document graph is constructed by treating each document as a node, and adding an edge between two nodes if two documents share some common words or phrases. In some embodiments, the graph embedding is obtained by applying a graph convolutional network (GCN) to a document graph.

In this embodiment, the relationship between different text documents can be modeled by using GNN, which can improve the retrieval efficiency and save time, and expand the response about the query document since the relationship between the query document and the retrieved document is taken into account.

In some embodiments, for each document, a vector representation of the document is obtained by concatenating its BERT vector and its graph embedding. This vector representation retains the semantic and structural information of the document, so it can improve the accuracy and efficiency of retrieval and make the response about the query document more accurate and richer.

In some embodiments, the query document can be encoded in the same way as the document library document, that is, using BERT and GNN. In some embodiments, the query document can be encoded in a different way from the document library document. The query vector is used to measure the dissimilarity to the document library vector in the next step.

It should be understood that BERT and GNN are provided as examples only, and other models, networks, or algorithms can be used to encode the documents.

At 306, the document library documents are sorted by a document sorting module. Sorting the documents includes calculating similarities between the target document and the multiple document library documents at 3062, and sorting the document library documents according to the similarities at 3064. In some embodiments, the document sorting module is intended to sort the document library documents according to their similarities to the query document. In some embodiment, the similarity between the query document and the multiple document library documents can be determined by calculating the cosine similarity between the document library vector and the query vector.

In some embodiments, the document sorting module is intended to sort the document library documents according to their dissimilarities to the query document. For example, the document sorting module calculates the cosine similarity between the query vector and the document library vector to achieve this goal. Cosine similarity is a metric of the similarity between two vectors based on the angle between them. The cosine similarity more particularly ranges from −1 to 1, where −1 indicates the opposite direction, 0 indicates the orthogonal direction, and 1 indicates the same direction.

The cosine similarity can capture the semantic and structural similarity between two documents based on the vector representation. The cosine similarity between the query vector and each document library vector is calculated as follows:

$$s i m ( q , c ) = \frac{q \cdot c}{‖ q ‖ ‖ c ‖} \qquad Equation 1$$

where q is the query vector, c is the document library vector, · is the dot product operation, and ∥ ∥ is the norm operation. In some embodiments, the cosine similarities between the query vector and the various document library vectors are sorted, and the document library documents are sorted in order of the cosine similarities. In some embodiments, the higher the cosine similarity, the more similar the document library document is to the query document. It should be understood that the cosine similarity is only provided as an example, and other similarity calculation methods can be used to determine the similarity between the query vector and each document library vector.

At 308, documents in the document library are filtered by a document filtering module. Filtering the document library documents includes, at 3082, applying a threshold to the similarity to filter out documents that do not meet the threshold among the multiple documents to obtain a filtered list, and at 3084, applying a clustering algorithm to the filtered list to filter out duplicate documents in the filtered list to obtain multiple second documents associated with the query document.

In some embodiments, the document filtering module is intended to filter out irrelevant or redundant document library documents from the sorted list. The document filtering module uses a threshold and a clustering algorithm to achieve this goal, for example, by applying the threshold to the cosine similarity to filter out document libraries that are too dissimilar to the query document. The threshold can be set to any value between 0 and 1 according to the desired similarity level. Only the document library documents with a cosine similarity that meets the threshold are saved in the filtered list. In some embodiments, documents that do not meet the threshold among the multiple documents are filtered to obtain a filtered list. It should be understood that not meeting the threshold can mean being above or below the threshold, depending on a specific implementation.

Then, the clustering algorithm is applied to the filtered list to group document libraries that are very similar to each other. The clustering algorithm is illustratively based on a DBSCAN algorithm, where DBSCAN denotes density-based spatial clustering of applications with noise. The DBSCAN algorithm can find a cluster of any shape and size, and can deal with noise and outliers. In some embodiments, the clustering algorithm uses the cosine similarity as a distance metric and two parameters: F and minPts, where F is the maximum distance between two points that are considered neighbors, and minPts is the minimum number of points that form a cluster. The clustering algorithm assigns each document library document to a class or tags it as noise.

In some embodiments, multiple document library documents in the same cluster are removed and filtered out, so as to filter out multiple document library documents that are excessively correlated and consequently duplicated, so that diversified document library documents can be left. In some embodiments, the document filtering module returns a filtered list of document library documents, along with their cluster tags and cosine similarity scores. The filtered list includes document library documents that are the most diversified and most correlated with the query document as multiple second documents.

It should be understood that the threshold and the clustering algorithm are provided only as examples, and other ways can be used to filter document library documents to obtain multiple second documents associated with the first document. As shown in FIG. 3, the process 300 further includes outputting the retrieved documents, that is, outputting multiple second documents associated with the first document, at 310.

Through the retrieval process 300, the semantic and structural information of the document is considered by using BERT and GNN to encode the document, and the multiple second documents that are most diversified and most correlated with the query document are obtained by applying two-step filtering to the similarity, so that the accuracy and efficiency of retrieval can be improved, and the response about the query document can be more accurate and richer.

FIG. 4 is a flow chart of a method 400 for retrieving multiple second documents associated with a first document according to some embodiments of the present disclosure. In order to better describe the method 400, it will be described below with reference to the example process 300 depicted in FIG. 3.

At 402, the first document and the multiple documents in the document library are encoded. In some embodiments, the first document and the multiple documents are encoded by the document encoding module in 304 of FIG. 3. In some embodiments, encoding the first document and the multiple documents in the document library includes encoding the first document as a first contextualized vector in a first dimensional space and as a first graph embedding in a second dimensional space, where the first dimension is higher than the second dimension. Each of the multiple documents is encoded as a second contextualized vector in the first dimensional space and as a second graph embedding in the second dimensional space. The first contextualized vector and the first graph embedding are concatenated to obtain a first feature representation, and the second contextualized vector and the second graph embedding are concatenated to obtain a second feature representation. In some embodiments, the feature representation may also be called a vector representation, which represents features extracted from a document in the vector space.

In some embodiments, the first dimensional space may correspond to a high-dimensional space, and the second dimensional space may correspond to a low-dimensional space. In some embodiments, the first feature representation may correspond to a vector representation of the query document, and the second feature may correspond to a vector representation of the document library document. In some embodiments, the vector representation of the query document may be called a query vector, which represents features extracted from the query document, and the vector representation of the document library document may be called a document library vector, which represents features extracted from the document library document.

At 404, a similarity between the first document and each of the multiple documents is determined. In some embodiments, determining the similarity between the first document and the multiple documents includes: determining a cosine similarity between the first document and each of the multiple documents according to the first feature representation and the second feature representation. It should be understood that the cosine similarity is only provided as an example, and any other similarity determination method can be used to determine the cosine similarity between the first document and each of the multiple documents.

At 406, the multiple documents are sorted according to the similarities. In some embodiments, the multiple documents are sorted according to the cosine similarity between the first document and each of the multiple documents. It should be understood that the multiple documents can be sorted using any sorting method. In some embodiments, 404 and 406 can be performed by the document sorting module in 306 of FIG. 3.

At 408, the multiple documents are filtered to obtain multiple second documents associated with the first document. In some embodiments, 408 can be performed by the document filtering module in 308 of FIG. 3. In some embodiments, filtering the multiple documents includes: applying a threshold to the similarity to filter out documents that do not meet the threshold among the multiple documents to obtain a filtered list; and applying a clustering algorithm to the filtered list to filter out duplicate documents in the filtered list to obtain multiple second documents. In some embodiments, the multiple second documents that are more diversified and more correlated with the first document can be obtained through two-step filtering with threshold and clustering. By comparing the multiple second documents that are highly correlated and diversified with the first document, a more reliable and valuable response can be obtained.

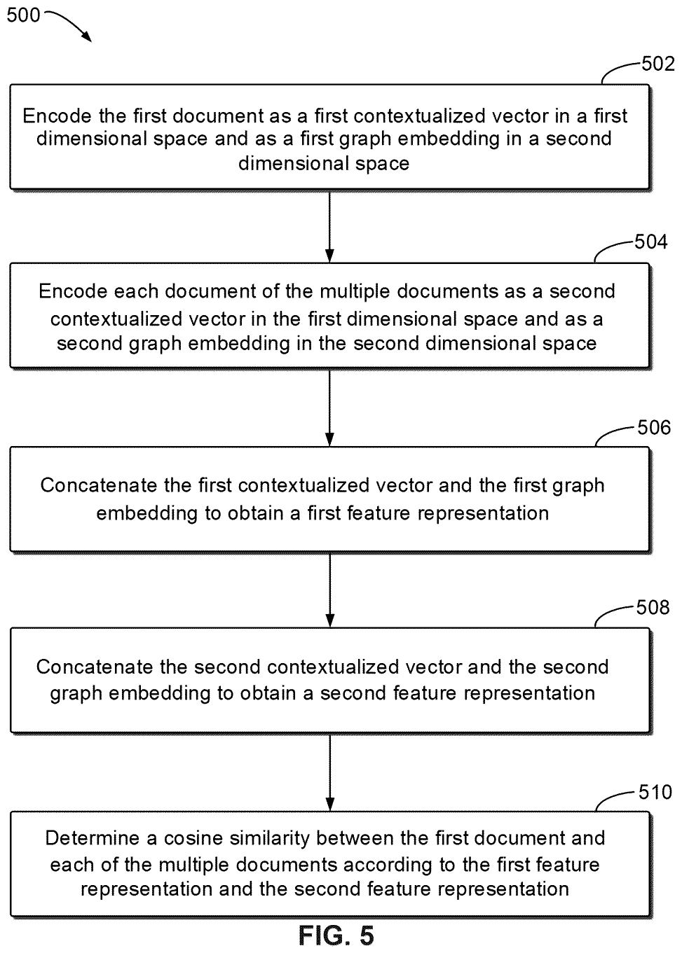

FIG. 5 is a flow chart of a method 500 for determining a similarity between the first document and the multiple documents in the document library according to some embodiments of the present disclosure.

At 502, the first document is encoded as a first contextualized vector in a first dimensional space and as a first graph embedding in a second dimensional space, where the first dimension is higher than the second dimension. At 504, each of the multiple documents is encoded as a second contextualized vector in the first dimensional space and as a second graph embedding in the second dimensional space. At 506, the first contextualized vector and the first graph embedding are concatenated to obtain a first feature representation. At 508, the second contextualized vector and the second graph embedding are concatenated to obtain a second feature representation.

In some embodiments, the method 500 further includes: at 510, determining a cosine similarity between the first document and each of the multiple documents according to the first feature representation and the second feature representation. For example, the cosine similarity between the first feature representation and the second feature representation can be calculated according to Equation 1 as described above.

In the method 500, the feature representation of each document is based on two extractions, that is, concatenating the contextualized vector in the high-dimensional space and the graph embedding in the low-dimensional space. The contextualized vector enables in-depth understanding of the text semantics behind keywords, so that more accurate retrieval results can be provided, and thus more accurate responses about the first document can be provided. The graph embedding can model the relationship between documents and can process multiple documents in batches, thereby improving the retrieval efficiency and saving time.

FIG. 6 is a schematic diagram of an architecture 600 of contextual analysis 602 of a document according to some embodiments of the present disclosure. In some embodiments, the hierarchical relationship 604 and substantial relationship (social relationship) 606 within the document are understood by the contextual analysis module 104 in FIG. 1. In some embodiments, the contextual analysis module 104 can achieve more in-depth understanding beyond the text level by using a capsule network 608 and discourse analysis 612.

The discourse analysis 612 refers to the linguistic analysis of the relationship between sentences, phrases, and words in the document. It can reveal how ideas, suppositions, grammar, and power dynamics are structured in the document. The discourse analysis 612 can reveal the theoretical values and ideas in the document.

As shown in FIG. 6, the contextual analysis 602 includes the hierarchical relationship 604 and the substantial relationship 606. It should be understood that the hierarchical relationship 604 refers to the organizational structure of multiple parts of the document, and the substantial relationship 606 refers to the substantial relationship between multiple parts of the document, such as the discourse relationship and the sentiment relationship.

As shown in FIG. 6, the hierarchical relationship 604 is determined by the capsule network 608 and a parse tree 610. In some embodiments, the capsule network 608 is applied to the vector representation of the encoded document from the retrieval module 102. The capsule network 608 is a neural network architecture that groups neurons into capsules to represent different attributes of the same entity. The capsule network 608 can simulate the hierarchical relationship by routing information between lower-level capsules and higher-level capsules.

In some embodiments, multiple parts of the document can be encoded into multiple capsules, with parts at the lower levels corresponding to the lower-level capsules and parts at higher levels corresponding to the higher-level capsules. For example, the document hierarchy can include: sentences, paragraphs, sub-chapters, chapters, and the like from bottom to top.

In some embodiments, chapters of the document are grouped into capsules at different levels to model the hierarchical relationship between them. In some embodiments, the higher-level capsules represent more abstract concepts, and the lower-level capsules represent simulated contents. The process of dynamic routing between the hierarchical capsules can provide contextual understanding of the document.

In some embodiments, a syntactic parse tree 610 is constructed for each sentence in the document using, for example, a parser. The parse tree 610 reveals the hierarchical structure and correlation between words and phrases in each sentence. In some embodiments, the structural information from the parse tree 610 can serve as a supplement to the capsule network 608. In some embodiments, the parse tree 610 may not be included. It should be understood that the capsule network 608 and the parse tree 610 are provided as examples only, and any different network or algorithm can be used to analyze the hierarchical relationship 604.

As shown in FIG. 6, the substantial relationship (social relationship) 606 of the document may include discourse analysis 612 and sentiment analysis 614. In some embodiments, the substantial relationship 606 can reveal the basic suppositions, values, and power dynamics in the document. In some embodiments, the discourse analysis can be applied by investigating the linguistic techniques, such as the rhetorical strategy, presupposition, hedging, and the like, used in the document by using the discourse analysis 612 and the sentiment analysis 614. This reveals the views and ideas hidden in the text.

The sentiment analysis 614 can be applied by detecting sentiment polarities (positive, negative, neutral) related to different entities and concepts in the document. In some embodiments, the sentiment analysis 614 provides clues about the attitudes and positions taken by the author. The concept-based sentiment analysis 614 can reveal sentiments for a specific target. By analyzing the hierarchical relationship 604 and the substantial relationship 606 in FIG. 6, a rich and multi-faceted understanding of the context in the document can be provided.

In an embodiment, the results from the capsule network 608, the parse tree 610, the discourse analysis 612, and the sentiment analysis 614 can be integrated to form a contextual analysis result. The contextual analysis result can be fed to the duplication detection module 108 and the question-and-answer module 112 of FIG. 1 for further processing. Since the architecture 600 of FIG. 6 provides a rich and multi-faceted understanding of the context in the document, it can improve the accuracy and breadth of document duplication detection and provide a more accurate and richer response about the document.

FIG. 7 is a schematic diagram of a process 700 of training a duplication detection module (e.g., 108 of FIG. 1) according to some embodiments of the present disclosure. The duplication detection module 108 is configured to identify a sematic similarity between the target document and the retrieved document. In an embodiment, the duplication detection module 108 utilizes a Siamese network for similarity learning. The Siamese network is a neural network that contains two identical sub-networks connected at the output. The same function is applied to the input pair to calculate a comparable output vector. The Siamese network learns the similarity metric in the input space by comparing similar and dissimilar input pairs.

As shown in FIG. 7, a query document 702, also referred to as a first document, and a retrieved document 706 are fed as inputs into the two sub-networks of the Siamese network. In an embodiment, the sub-networks have the same encoders 704 and 708 based on BERT and GNN. In some embodiments, a contrastive loss function 710 pulls the codes of a similar pair together and pushes the codes of a dissimilar pair away.

The application of BERT and GNN in the duplication detection module 108 can take into account the semantic information in the documents and the relationship between documents, so it can improve the accuracy and efficiency of duplication detection and make the response about the query document more accurate and richer.

In some embodiments, the Siamese network is trained by the duplication detection module 108 using multiple documents in the document library. For example, two documents among the multiple documents are input to the two sub-networks of the Siamese network, and the contrastive loss function 710 is calculated. The parameters of the encoder are adjusted by making the contrastive loss function 710 as small as possible to train the Siamese network. By training the Siamese network, more accurate duplication detection results can be obtained.

In some embodiments, the duplication detection module 108 compares the query document contextually analyzed with multiple retrieved documents contextually analyzed by using the trained Siamese network to determine the duplication between the query document and the multiple retrieved documents.

In some embodiments, the trained Siamese network can then accurately predict a similarity score for a pair of the target document and the detected document. The similarity score can show the degree of duplication between the target document and the detected document.

The training process 700 of FIG. 7 can provide simpler lexical and semantic similarity metrics by learning a complex similarity function customized for the document, thus improving the accuracy of duplication detection and further providing a more accurate response about the target document.

It should be understood that the models, networks, and algorithms described with respect to FIG. 7 are only provided as examples, and different models, networks, and algorithms may be used for duplication detection.

FIG. 8 is a schematic diagram of a process 800 of gap detection according to some embodiments of the present disclosure. In some embodiments, the gap detection is performed by the gap detection module 110 of FIG. 1 according to the first document and the multiple second documents that are causally analyzed. The gap detection module 110 is configured to identify the gap or uncovered area (i.e., novelty) of the first document relative to the second documents. In some embodiments, the gap detection module 110 discovers a new subject matter and content (i.e., novelty) by using the zero-sample learning technique.

As shown in FIG. 8, the gap detection process 800 includes: at 802, inputting a part of a first document; at 804, encoding the part of the first document as a first embedding using a BERT encoder; at 806, mapping the first embedding to a semantic space; at 808, inputting multiple parts of multiple documents; at 810, encoding the multiple parts of the multiple second documents as a second embedding using a BERT encoder; at 812, mapping the multiple second embeddings to the semantic space; and at 814, performing gap detection. For example, at 814, the mapped first embedding is compared with the mapped multiple second embeddings to determine gaps between the first document and the multiple second documents.

In some embodiments, the first document and the second documents input at 802 and 804 are documents causally analyzed, that is, documents from the causal analysis module 106. In some embodiments, the gap represents the novelty of the first document, that is, new research issues, theories, or methods not covered in the first document.

In some embodiments, the causal analysis module 106 can infer the causal relationship in a document, that is, causal relationship between multiple parts of the document. It should be understood that the multiple parts of the document may include multiple pages, chapters, paragraphs, sentences, or the like of the document. In some embodiments, the causal module understands the causal logic and measures the contextual significance by using the causal modeling and an attention mechanism.

It should be understood that the causal modeling refers to a statistical technique that models the causal relationship between variables, as opposed to modeling only the correlation. The causal model can represent the causal mechanism for generating observation data. For example, the causal discover algorithm can infer a reasonable causal relationship from the observation data. Embodiments of the present disclosure can obtain more accurate gap detection results by inferring the causal relationship between multiple parts of the document by using the causal discovery algorithm.

In some embodiments, the attention mechanism refers to a neural network technique that learns by assigning different attention weights to various parts of the input, so as to focus on the relevant parts of the input. It should be understood that the attention weight indicates the relative significance of each part of the input.

In some embodiments, the causal analysis includes causal graph construction and attention weighing. The causal graph and the attention weight can provide a supplementary understanding of the causal hypothesis and focus of the document author. The causal information obtained through the causal analysis enhances the understanding of the context of the document.

In some embodiments, the causal graph construction is intended to infer the causal mechanism in the document. The causal discovery algorithm is applied to the encoded vector representation of the document part from the retrieval module 102. Different variable selection and causal structure learning techniques can be used to construct a causal graph. In some embodiments, the causal graph can be constructed by discovering a causal skeleton using a sequential correlation algorithm (e.g., a Peter-Clark (PC) algorithm) and orienting edges using a graph embedding algorithm with edge information (e.g., a Greedy Equivalence Search (GES) algorithm). For example, the constructed causal graph represents the hypothetical causality between the concepts and variables of key parts of the document. It provides an understanding of the hypothetical causality logic of the document author.

In some embodiments, attention weighing is intended to identify the contextual significance of different parts of the document. The self-attention layer can be incorporated into the neural network architecture used to encode the documents. The attention weight assigned to each part indicates the relevance and significance of that part for understanding the whole document. It should be understood that the above models, networks, or algorithms are provided as examples only, and different models, networks, or algorithms can be used to carry out the causal analysis.

In some embodiments, novel categories that are not seen during training are identified by using the zero-sample learning. A transformer-based model similar to BERT is used to generate vector representation of unseen text snippets. These vectors are projected into the existing semantic classification space, and novel clusters corresponding to new subject matters are identified using the nearest neighbor search. It should be understood that the semantic information of documents can be taken into account when using the BERT encoder to encode the documents, thus providing more accurate novel clustering and gap results.

In some embodiments, new snippets from the first document are embedded using BERT and compared with the embedding of known snippets of topics derived from the retrieved document. In some embodiments, the novel cluster represents the gap between the first document relative to the second document, which can generate responses related to new research issues, theories, or methods not covered in the first document. By using zero sample learning, the gap detection module 110 can effectively identify the gap and reveal areas beyond the boundaries of existing subject matters and content. This helps to generate responses of potential research issues, theories, or methods about the first document.

In some embodiments, determining the gaps between the first document and the multiple second documents includes the gap detection module 110 encoding a part of the first document as a first embedding and encoding multiple parts of the multiple second documents as multiple second embeddings; mapping the first embedding to the semantic space; mapping the multiple second embeddings to the semantic space; and comparing the mapped first embedding with the mapped multiple second embeddings to determine the gaps between the first document and the multiple second documents. It should be understood that the above models, networks, and algorithms are only provided as examples, and different models, networks, and algorithms can be used for gap detection.

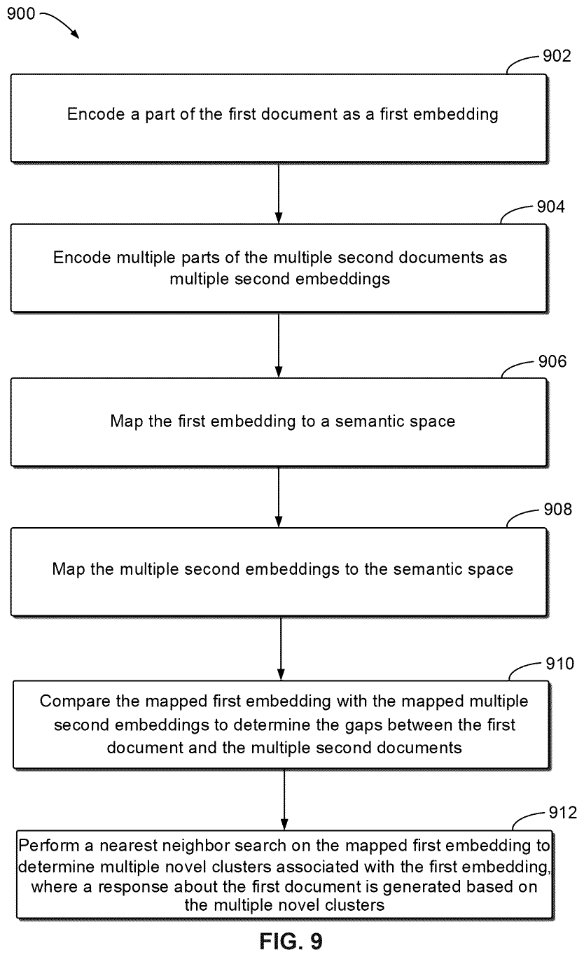

FIG. 9 is a flow chart of a method 900 for gap detection according to some embodiments of the present disclosure. It should be understood that the method 900 can be associated with the process 800. At 902, a part of the first document is encoded as a first embedding. At 904, multiple parts of the multiple second documents are encoded as multiple second embeddings. At 906, the first embedding is mapped to the semantic space. At 908, the multiple second embeddings are mapped to the semantic space. At 910, the mapped first embedding is compared with the mapped multiple second embeddings to determine the gaps between the first document and the multiple second documents.

At 912, a nearest neighbor search is performed on the mapped first embedding to determine multiple novel clusters associated with the first embedding, and a response about the first document is generated based on the multiple novel clusters. In some embodiments, the novel clusters are associated with the gaps between the first document and the multiple second documents. For example, the response about the first document generated according to the novel clusters can indicate the novelty of the first document, that is, new and uncovered research directions, research issues, theories, methods, or the like. Conventional methods only compare the first document with the retrieved document and provide the gaps between them, but cannot detect the novelty or provide a response about the novel uncovered areas of the first document.

Embodiments of the present disclosure can provide a semantic vector representation that captures the meaning of a document more accurately than keywords through the application of BERT, and can provide an overall perspective across documents through the application of GNN. Understanding the language context and causality provides more in-depth understanding of the knowledge and logic behind the text, and the zero-sample gap detection capability enables the identification of novel contributions that are not covered in the current document. Generally, embodiments of the present disclosure provide significantly enhanced performance and rich contextual understanding and inference in duplication detection and gap analysis, so as to better simulate human understanding of texts.

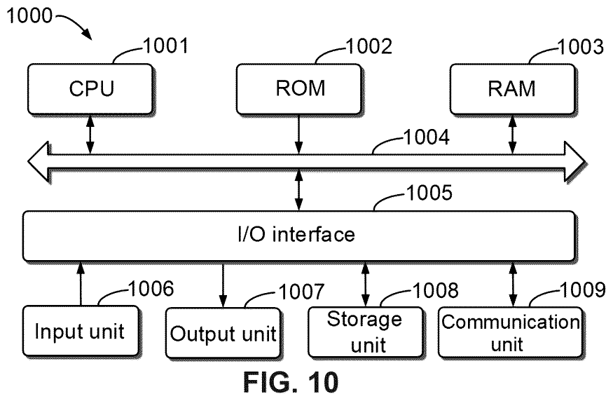

FIG. 10 is a block diagram of an example device 1000 that can be used to implement embodiments of the present disclosure. As shown in the figure, the device 1000 includes a computing unit 1001, illustratively implemented as at least one central processing unit (CPU), that can perform various appropriate actions and processing according to computer program instructions stored in a read-only memory (ROM) 1002 or computer program instructions loaded from a storage unit 1008 to a random access memory (RAM) 1003. Various programs and data required for the operation of the device 1000 may also be stored in the RAM 1003. The computing unit 1001, the ROM 1002, and the RAM 1003 are connected to each other through a bus 1004. An input/output (I/O) interface 1005 is also connected to the bus 1004.

Multiple components in the device 1000 are connected to the I/O interface 1005, including: an input unit 1006, such as a keyboard and a mouse; an output unit 1007, such as various types of displays and speakers; the storage unit 1008, such as a magnetic disk and an optical disc; and a communication unit 1009, such as a network card, a modem, and a wireless communication transceiver. The communication unit 1009 allows the device 1000 to exchange information/data with other devices via a computer network, such as the Internet, and/or various telecommunication networks.

The computing unit 1001 may comprise various general-purpose and/or special-purpose processing components with processing and computing power. Some examples of the computing unit 1001 include, but are not limited to, the above-noted one or more CPUs, graphics processing units (GPUs), various specialized artificial intelligence (AI) computing chips, various computing units for running machine learning model algorithms, digital signal processors (DSPs), and any appropriate processors, controllers, microcontrollers, and the like. The computing unit 1001 performs various methods and processes described above, such as the methods 200, 400, 500, and 900 and the processes 300, 700, and 800. For example, in some embodiments, the methods 200, 400, 500, and 900 and the processes 300, 700, and 800 may be implemented as computer software programs, which are tangibly embodied in a machine-readable medium such as the storage unit 1008. In some embodiments, part or all of the computer program may be loaded and/or installed onto the device 1000 via the ROM 1002 and/or the communication unit 1009. When the computer program is loaded into the RAM 1003 and executed by the computing unit 1001, one or more steps of the methods 200, 400, 500, and 900 and the processes 300, 700, and 800 described above can be performed. Alternatively, in other embodiments, the computing unit 1001 may be configured to perform the methods 200, 400, 500, and 900 and the processes 300, 700, and 800 by any other suitable means (for example, by means of firmware).

The functions described hereinabove may be performed at least in part by one or more hardware logic components. For example, without limitation, example types of hardware logic components that can be used include: a field programmable gate array (FPGA), an application specific integrated circuit (ASIC), an application specific standard product (ASSP), a system on chip (SOC), a complex programmable logic device (CPLD), and the like.

Program codes for implementing the method of the present disclosure may be written by using one programming language or any combination of multiple programming languages. The program codes may be provided to a processor or controller of a general-purpose computer, a special-purpose computer, or another programmable data processing apparatus, such that the program codes, when executed by the processor or controller, implement the functions/operations specified in the flow charts and/or block diagrams. The program codes may be executed completely on a machine, executed partially on a machine, executed partially on a machine and partially on a remote machine as a stand-alone software package, or executed completely on a remote machine or server.

In the context of the present disclosure, a machine-readable medium may be a tangible medium that may include or store a program for use by an instruction execution system, apparatus, or device or in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include one or more wire-based electrical connections, a portable computer diskette, a hard disk, a RAM, a ROM, an erasable programmable read-only memory (EPROM or flash memory), an optical fiber, a portable compact disc read-only memory (CD-ROM), an optical storage device, a magnetic storage device, or any suitable combination thereof. Additionally, although operations are depicted in a particular order, this should not be construed as an indication that such operations are required to be performed in the particular order shown or in a sequential order, or that all illustrated operations should be performed to achieve desirable results. In certain environments, multitasking and parallel processing may be advantageous. Likewise, although the above discussion contains several specific implementation details, these should not be construed as limitations to the scope of the present disclosure. Certain features that are described in the context of separate embodiments may also be implemented in combination in a single implementation. In contrast, various features that are described in the context of a single implementation may also be implemented in multiple implementations separately or in any suitable sub-combination.

Although the present subject matter has been described using a language specific to structural features and/or method logical actions, it should be understood that the subject matter defined in the appended claims is not necessarily limited to the particular features or actions described above. Rather, the specific features and actions described above are merely example forms in which the claims are implemented.

What is claimed is:

1. A method comprising:
according to a first document, retrieving multiple second documents associated with the first document;
determining duplication between the first document and the multiple second documents through contextual analysis of the first document and the multiple second documents;
determining gaps between the first document and the multiple second documents through causal analysis of the first document and the multiple second documents; and
generating a response about the first document according to the duplication and the gaps using a language model.

2. The method according to claim 1, wherein retrieving multiple second documents associated with the first document comprises:
encoding the first document and multiple documents in a document library;
determining a similarity between the first document and each of the multiple documents;
sorting the multiple documents according to the similarities; and
filtering the multiple documents to obtain the multiple second documents associated with the first document.

3. The method according to claim 2, wherein encoding the first document and multiple documents in the document library comprises:
encoding the first document as a first contextualized vector in a first dimensional space and as a first graph embedding in a second dimensional space, wherein the first dimension is higher than the second dimension;
encoding each of the multiple documents as a second contextualized vector in the first dimensional space and as a second graph embedding in the second dimensional space;
concatenating the first contextualized vector and the first graph embedding to obtain a first feature representation; and
concatenating the second contextualized vector and the second graph embedding to obtain a second feature representation.

4. The method according to claim 3, wherein determining similarities between the first document and the multiple documents comprises:
determining a cosine similarity between the first document and each of the multiple documents according to the first feature representation and the second feature representation.

5. The method according to claim 2, wherein filtering the multiple documents comprises:
applying a threshold to the similarity to filter out documents whose similarities are lower than the threshold among the multiple documents to obtain a filtered list; and
applying a clustering algorithm to the filtered list to filter out duplicate documents in the filtered list to obtain the multiple second documents.

6. The method according to claim 1, wherein performing contextual analysis on the first document comprises:
determining a hierarchical relationship between multiple parts of the first document, the hierarchical relationship being determined by using a capsule network and a parse tree; and
determining a substantial relationship between the multiple parts of the first document, the substantial relationship comprising a discourse relationship and a sentiment relationship between the multiple parts.

7. The method according to claim 1, wherein determining duplication between the first document and the second documents comprises:
training a Siamese network using multiple documents in a document library; and
comparing the first document contextually analyzed and the multiple second documents contextually analyzed by using the trained Siamese network to determine the duplication between the first document and the second documents.

8. The method according to claim 1, wherein performing causal analysis on the first document comprises:
determining a graphical representation of a causal relationship between multiple parts of the first document; and
determining attention weights of the multiple parts of the first document in the graphical representation.

9. The method according to claim 8, wherein performing causal analysis on the first document further comprises:
sorting the attention weights of the multiple parts of the first document;
applying a first threshold to the attention weights of the multiple parts; and
selecting the part of the first document with an attention weight higher than the first threshold as the first document causally analyzed.

10. The method according to claim 1, wherein determining gaps between the first document and the multiple second documents comprises:
encoding a part of the first document as a first embedding;
encoding multiple parts of the multiple second documents as multiple second embeddings;
mapping the first embedding to a semantic space;
mapping the multiple second embeddings to the semantic space; and
comparing the mapped first embedding with the mapped multiple second embeddings to determine the gaps between the first document and the multiple second documents.

11. The method according to claim 10, wherein generating the response about the first document comprises:
performing a nearest neighbor search on the mapped first embedding to determine multiple novel clusters associated with the first embedding, wherein the response about the first document is generated based on the multiple novel clusters.

12. An electronic device, comprising:
at least one processor; and
a memory coupled to the at least one processor and having instructions stored therein, the instructions, when executed by the at least one processor, causing the electronic device to perform actions comprising:
according to a first document, retrieving multiple second documents associated with the first document;
determining duplication between the first document and the multiple second documents through contextual analysis of the first document and the multiple second documents;
determining gaps between the first document and the multiple second documents through causal analysis of the first document and the multiple second documents; and
generating a response about the first document according to the duplication and the gaps using a language model.

13. The electronic device according to claim 12, wherein retrieving multiple second documents associated with the first document comprises:
encoding the first document and multiple documents in a document library;
determining a similarity between the first document and each of the multiple documents;
sorting the multiple documents according to the similarities; and
filtering the multiple documents to obtain the multiple second documents associated with the first document.

14. The electronic device according to claim 13, wherein encoding the first document and multiple documents in the document library comprises:
encoding the first document as a first contextualized vector in a first dimensional space and as a first graph embedding in a second dimensional space, wherein the first dimension is higher than the second dimension;
encoding each of the multiple documents as a second contextualized vector in the first dimensional space and as a second graph embedding in the second dimensional space;
concatenating the first contextualized vector and the first graph embedding to obtain a first feature representation;
concatenating the second contextualized vector and the second graph embedding to obtain a second feature representation; and
determining a cosine similarity between the first document and each of the multiple documents according to the first feature representation and the second feature representation.

15. The electronic device according to claim 13, wherein filtering the multiple documents comprises:
applying a threshold to the similarity to filter out documents whose similarities are lower than the threshold among the multiple documents to obtain a filtered list; and
applying a clustering algorithm to the filtered list to filter out duplicate documents in the filtered list to obtain the multiple second documents.

16. The electronic device according to claim 12, wherein performing contextual analysis on the first document comprises:
determining a hierarchical relationship between multiple parts of the first document, the hierarchical relationship being determined by using a capsule network and a parse tree; and
determining a substantial relationship between the multiple parts of the first document, the substantial relationship comprising a discourse relationship and a sentiment relationship between the multiple parts.

17. The electronic device according to claim 12, wherein determining duplication between the first document and the second documents comprises:
training a Siamese network using multiple documents in a document library; and
comparing the first document contextually analyzed and the multiple second documents contextually analyzed by using the trained Siamese network to determine the duplication between the first document and the second documents.

18. The electronic device according to claim 12, wherein performing causal analysis on the first document comprises:
determining a graphical representation of a causal relationship between multiple parts of the first document;
determining attention weights of the multiple parts of the first document in the graphical representation;
sorting the attention weights of the multiple parts of the first document;
applying a first threshold to the attention weights of the multiple parts; and
selecting the part of the first document with an attention weight higher than the first threshold as the first document causally analyzed.

19. The electronic device according to claim 12, wherein determining gaps between the first document and the multiple second documents comprises:
encoding a part of the first document as a first embedding;
encoding multiple parts of the multiple second documents as multiple second embeddings;
mapping the first embedding to a semantic space;
mapping the multiple second embeddings to the semantic space; and
comparing the mapped first embedding with the mapped multiple second embeddings to determine the gaps between the first document and the multiple second documents.

20. A computer program product that is tangibly stored on a non-transitory computer-readable medium and comprises machine-executable instructions that, when executed by a machine, cause the machine to perform actions comprising:
according to a first document, retrieving multiple second documents associated with the first document;
determining duplication between the first document and the multiple second documents through contextual analysis of the first document and the multiple second documents;
determining gaps between the first document and the multiple second documents through causal analysis of the first document and the multiple second documents; and
generating a response about the first document according to the duplication and the gaps using a language model.
